(19) United States
(12) Patent Application Publication
(10) Pub. No.: US 2008/0137594 A1
(43) Pub. Date: Jun. 12, 2008

(54) APPARATUS AND METHOD FOR INCREASING A SERVICE COVERAGE AREA OF A BROADCAST CHANNEL IN WIRELESS COMMUNICATION SYSTEM BY USING AN HARQ SCHEME

(75) Inventors: Kwan-Hee ROH, Hwaseong-si (KR); Tae-Young KIM, Seongnam-si (KR); Jae-Hee CHO, Seoul (KR); Jeong-Ho PARK, Seoul (KR); Jin-Kyu KOO, Suwon-si (KR)

Correspondence Address: Jefferson IP Law, LLP, 1730 M Street, NW, Suite 807, Washington, DC, 20036, US

(73) Assignee: SAMSUNG ELECTRONICS CO., LTD., Suwon-city (KR)

(21) Appl. No.: 11/952,439

(22) Filed: Dec. 7, 2007

(30) Foreign Application Priority Data
Dec. 7, 2006 (KR) 10-2006-0123877

(51) Int. Cl. H04Q 7/00

(52) U.S. Cl. 370/328

(57) ABSTRACT

Provided is an apparatus and method for increasing the service coverage area of a broadcast channel in a wireless communication system by using a Hybrid Automatic Repeat reQuest (HARQ) scheme. The method receives a MAP message including information about the type of a Media Access Control (MAC) management message transmitted in the current frame and information about retransmission of the MAC management message. Upon receipt of the MAC management message, based on the received information, the method combines the received MAC management message with a MAC management message that is stored in a buffer, wherein the MAC management message that is stored in the buffer was stored due to a reception error.

### PRIORITY

This application claims the benefit under 35 U.S.C. §119(a) of a Korean patent application filed on Dec. 7, 2006 in the Korean Intellectual Property Office and assigned Serial No. 2006-123877, the entire disclosure of which is hereby incorporated by reference.

### BACKGROUND OF THE INVENTION

1. Field of the Invention

The present invention relates to an apparatus and method for increasing a service coverage area of a broadcast channel in a wireless communication system. More particularly, the present invention relates to an apparatus and method for increasing a service coverage area of a broadcast channel in a wireless communication system by using a Hybrid Automatic Repeat reQuest (HARQ) scheme.

2. Description of the Related Art

Broadband wireless communication systems transmit signals to users in one of a unicast scheme and a broadcast scheme. In the unicast scheme, a signal is separately transmitted to each user terminal. In the broadcast scheme, a signal is commonly transmitted to each of the user terminals associated with a base station. However, proper operation of the broadcast scheme requires that the each of the user terminals associated with a base station be able to successfully receive the commonly transmitted signal. Thus, the broadcast scheme uses a more robust modulation scheme than the unicast scheme.

Exemplary Media Access Control (MAC) management broadcast messages include an Uplink Channel Descriptor (UCD) message, a Downlink Channel Descriptor (DCD) message, a DownLink MAP (DL-MAP) message, an UpLink MAP (UL-MAP) message, a CLocK_CoMParison (CLK_CMP) message, a Fast Power Control (FPC) message, a MOBile_NeighBoR-ADVertisement (MOB_NBR-ADV) message, and a MOBile_PAGing-ADVertisement (MOB_PAG-ADV) message. The MAC management message contains important information such as information about access to the system, start/end of the service, determination of a transmission scheme, and allocation of resources. Thus, if a user terminal cannot successfully receive the above messages, it cannot receive an adequate level of service, which may adversely affect another user terminal associated with the base station.

In general, the system coverage area is determined based on the service coverage area of the MAC management message and the service coverage area of data traffic transmitted to each user terminal. However, the service coverage area of the MAC management message is more important since it has a greater effect on the ability to guarantee satisfactory system operation. User terminals with good channel conditions and user terminals with poor channel conditions may coexist in the system. Therefore, control information is transmitted using a robust modulation scheme so that even a user terminal with poor channel conditions can successfully receive data.

The service coverage area for the transmission of control information may be increased by any combination of increasing the quality of the received signal and using a more robust coding scheme. In order to increase the quality of a received signal, a power boosting scheme is used to increase the transmission (TX) power of a subcarrier within a transmission power range. Further, a low coding rate scheme may be used by reducing a coding to provide a more robust coding scheme. In addition, the service coverage area may be increased by using an HARQ scheme and an Interference Cancellation (IC) scheme that reduces the influence of an interference signal.

The DCD/UCD message includes a Configuration Change Count field. Based on the value of the Configuration Change Count field, a user terminal detects whether there is data that has changed with respect to the previously received DCD or UCD message. If the Configuration Change Count field has changed, the user terminal determines that information contained in the previously received message is not valid any more, and then once again decodes the DCD or UCD message to obtain new parameters.

For example, the DL-MAP and UL-MAP messages of the IEEE 802.16 system may be formatted as set forth in Tables 1 and 2 below. Also, the DCD and UCD messages may be formatted as set forth in Tables 3 and 4 below. Upon receipt of the MAP message, a user terminal detects information about a burst allocated to itself and information about a broadcast burst commonly transmitted to all the user terminals from a DownLink Map Information Element (DL-MAP_IE) field of the received MAP message. Thereafter, the user terminal selects and receives the necessary burst. Because the MAC management message is transmitted over a broadcast channel, every user terminal in the base station receives a corresponding burst and can detect which MAC management message the corresponding burst corresponds to, based on a Management Message Type field.

TABLE 1

| Syntax | Size |
|---|---|
| DL-MAP_Message_Format { | |
| Management Message Type = 2 | 8 bits |
| PHY Synchronization Field | variable |
| DCD Count | 8 bits |
| Base Station ID | 48 bits |
| Begin PHY Specific Section { | |
| if(Wireless MAN-OFDMA) { | |
| No. OFDMA symbols | 8 bits |
| } | |
| for (i=1; i<=n; i++) { | |
| DL-MAP_IE( ) | variable |
| } | |
| } | |
| if!(byte boundary) { | |
| Padding Nibble | 4 bits |
| } | |
| } | |

TABLE 2

| Syntax | Size |
|---|---|
| UL-MAP_Message_Format { | |
| Management Message Type = 3 | 8 bits |
| Reserved | 8 bits |
| UCD Count | 8 bits |
| Allocation Start Time | 32 bits |
| Begin PHY Specific Section { | |
| if(Wireless MAN-OFDMA) { | |
| No. OFDMA symbols | 8 bits |
| } | |
| for (i=1; i<=n; i++) { | |
| DL-MAP_IE() | variable |
| } | |
| } | |
| if!(byte boundary) { | |
| Padding Nibble | 4 bits |
| } | |
| } | |

TABLE 3

| Syntax | Size |
|---|---|
| DCD_Message_Format { | |
| Management Message Type = 1 | 8 bits |
| Downlink Channel ID | 8 bits |
| Configuration Change Count | 8 bits |
| TLV encoded information for the overall channel | variable |
| Begin PHY Specific Section { | |
| For (i=1; i<=n; i++) { | |
| Downlink_Burst_Profile | PHY |
| | sepcific |
| } | |
| } | |
| } | |

TABLE 4

| Syntax | Size |
|---|---|
| UCD_Message_Format { | |
| Management Message Type = 0 | 8 bits |
| Configuration Change Count | 8 bits |
| Ranging Backoff Start | 8 bits |
| Ranging Backoff End | 8 bits |
| Request Backoff Start | 8 bits |
| Request Backoff End | 8 bits |
| TLV encoded information for the overall channel | variable |
| Begin PHY Specific Section { | |
| For (i=1; i<=n; i++) { | |
| Uplink_Burst_Profile | PHY |
| | sepcific |
| } | |
| } | |
| } | |

As described above, examples of the MAC management messages transmitted over the broadcast channel include an UCD message, a DCD message, a DL-MAP message, a CLK_CMP message, an FPC message, an MOB_NBR-ADV message, and an MOB_PAG-ADV message. The UCD message, the DCD message, and the MOB_NBR-ADV message include a large amount of information and take a long time to transmit. By contrast, the DL-MAP message and the UL-MAP message include only a small amount of information but the DL-MAP message and the UL-MAP message must be transmitted in each frame.

In the case of a small amount of TX information, the power boosting scheme, the low coding rate scheme, or the interference cancellation scheme may be used when increasing the service coverage area for transmission of the control information. However, in the case of a large amount of TX information amount, the power boosting scheme, the low coding rate scheme, or the interference cancellation scheme is difficult to apply due to limited wireless resources. For example, control information such as FCH, DL-MAP and UL-MAP in the IEEE 802.16 system is made up of a relatively small amount of information and thus the coverage area can be increased by increasing the number of repetitions or by the boosting scheme. However, control information such as DCD and UCD is made up of a relatively large amount of information (up to 300 bytes for DCD and up to 270 bytes for UCD) and thus the boosting scheme is difficult to apply due to the limited TX power of the base station.

Herein, the MAC management message such as DCD and UCD contains important parameter information such as a burst profile and a ranging parameter that is necessary for a user terminal to attempt to enter the network or to maintain communication with a base station. Thus, in order to receive service, the user terminal must receive a MAC management message and obtain related system parameter information from the MAC management message. Also, when the parameter value changes, the user terminal must be able to detect the change. However, even when the service coverage area of the MAP message increases, the service coverage area of a long management message for a broadcast channel, such as DCD and UCD, remains unchanged. The HARQ scheme may be used to increase the service coverage area of the long management message. Use of the HARQ scheme requires reporting whether the transmitted data is retransmitted data or if this is the first time the data is being transmitted. However, the MAP message according to the existing IEEE 802.16 standards cannot report information about the type of a transmitted MAC management message and information necessary for HARQ recombination. The IEEE 802.16 standards are hereby incorporated by reference in their entirety.

What is therefore required is a scheme for increasing the service coverage area of the corresponding broadcast channel so that even a user terminal, which is located in a cell boundary region or has poor channel conditions, can receive the corresponding data using the HARQ retransmission scheme, in the case of transmission of a broadcast channel for a long management message such as DCD, UCD, and MBR-ADV, which has a large amount of information but doesn't change for long periods of time.

### SUMMARY OF THE INVENTION

An aspect of the present invention is to address at least the above mentioned problems and/or disadvantages and to provide at least the advantages below. Accordingly, an aspect of the present invention is to provide an apparatus and method for increasing the service coverage area of a broadcast channel in a wireless communication system by using an HARQ scheme.

Another aspect of the present invention is to provide an apparatus and method for increasing a service coverage area using an HARQ scheme when a management message with a large information size among control information is transmitted in a wireless communication system.

Still another aspect of the present invention is to provide an apparatus and method for increasing a service coverage area in a wireless communication system, in which a base station transmits a MAP message, which contains information about the type of a long management message transmitted in the current frame and information about retransmission of the long management message for HARQ recombination, to a user terminal and the user terminal performs HARQ recombination for the long management message received from the base station.

According to one aspect of the present invention, a method for increasing the service coverage area of a broadcast channel in a wireless communication system is provided. The method includes receiving a MAP message comprising information about the type of a MAC management message transmitted in the current frame and information about retransmission of the MAC management message, and upon receipt of the MAC management message, based on the received information, combining the received MAC management message with a MAC management message that is stored in a buffer, wherein the MAC management message that is stored in the buffer was stored due to a reception error.

According to another aspect of the present invention, an apparatus for increasing the service coverage area of a broadcast channel in a wireless communication system is provided. The apparatus includes a MAP decoder for decoding a received MAP message to extract information about the type of a MAC management message transmitted in the current frame and information about retransmission of the MAC management message, and an HARQ recombination determiner for determining, based on the extracted information, whether to combine the MAC management message transmitted in the current frame with a MAC management message that is stored in a buffer, wherein the MAC management message that is stored in the buffer was stored due to a reception error.

Other aspects, advantages, and salient features of the invention will become apparent to those skilled in the art from the following detailed description,

### BRIEF DESCRIPTION OF THE DRAWINGS

The above and other aspects, features and advantages of certain exemplary embodiments of the present invention will become more apparent from the following detailed description taken in conjunction with the accompanying drawings, in which:

FIG. 1 is a diagram illustrating the service coverage area of a MAP message using a general data burst and a coverage area increasing scheme in a user terminal of a wireless communication system according to an exemplary embodiment of the present invention;

FIG. 2 is a block diagram of an apparatus for applying an HARQ scheme to a long management message in a user terminal of a wireless communication system according to an exemplary embodiment of the present invention; and

FIG. 3 is a flowchart illustrating a method for applying an HARQ scheme to a long management message in a user terminal of a wireless communication system according to an exemplary embodiment of the present invention.

Throughout the drawings, like reference numerals are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide an apparatus and method for increasing the service coverage area of a broadcast channel in a wireless communication system by using an HARQ scheme. The following description is made in the context of the IEEE 802.16 system, to which the exemplary embodiments of the present invention are not limited. Thus, it is to be clearly understood that the exemplary embodiments of the present invention are applicable to any communication system that uses a long management message. In the following description, because a user terminal must be able to receive a DL-MAP message in order to receive a MAC management message, it is assumed that the coverage area of a DL-MAP message is sufficiently guaranteed by implementing a boosting scheme or an interference cancellation scheme.

In the IEEE 802.16 system, for transmission of MAC management messages, a receiving point is designated using a Channel IDentification (CID) field of a DL-MAP message. Additionally, the DCD and UCD among the MAC management messages use a fragmentable broadcast CID. Furthermore, the remaining broadcast information, such as NBR-ADV and PAG-ADV, uses a broadcast CID. A user terminal, which is located within the MAP service coverage area but cannot receive broadcast information, such as DCD and UCD, can receive a MAP message successfully even though it cannot successfully receive the corresponding broadcast information. To overcome the inability to receive broadcast information, recombination by HARQ retransmission may be used to receive the corresponding broadcast information. Herein, which management message a data burst that is transmitted through the corresponding MAP_IE corresponds to must be detected in order to use the HARQ retransmission scheme. However, because the information is included in a MAC header of the corresponding data burst, a user terminal located in a region incapable of receiving the data burst cannot use the HARQ recombination. Also, in order to use the HARQ recombination, the user terminal must be able to detect information about a management message type of the data burst and information about the retransmission. Thus, as shown in Table 5 below, an exemplary embodiment of the present invention adds an ARQ Channel IDentification (ACID) field and an ARQ Identifier_Sequence Number (AI_SN) field in a DL-MAP_IE message. Because the ACID field and the AI_SN field are necessary only for a broadcast CID and a fragmentable broadcast CID, they exist only for the corresponding CID type.

TABLE 5

| Syntax | Size |
|---|---|
| DL-MAP_IE { | |
| DIUC | 4 bits |
| if(DIUC= =14) { | |
| Extended-2 DIUC dependent IE | 8 bits |
| } else if(DIUC = = 15) { | |
| Extended DIUC dependent IE | variable |
| } else { | |
| if(INC_CID = = 1) { | — |
| N_CID | 8 bits |
| For (n=1; n<=N_CID; n++) { | |
| if(included in SUB-DL-UL_MAP) { | |
| RCID_IE( ) | |
| } else { | |
| CID | 16 bits |
| if(CID = = broadcast CID or Fragmentable | |
| broadcast CID) { | |
| ACID | N |
| AI_SN | M |
| } | |
| } | |
| } | |
| OFDMA Symbol offset | 8 bits |
| if(Permutation = 0b11 and AMC type is 2x3 or 1x6) { | |
| Subchannel offset | 8 bits |
| Boosting | 3 bits |
| No. OFDMA triple symbols | 5 bits |
| No. Subchannels | 6 bits |
| } else { | |
| Subchannel offset | 6 bits |
| Boosting | 3 bits |
| No. OFDMA symbols | 7 bits |
| No. Subchannels | 6 bits |
| } | |
| Repetition Coding Indication | 2 bits |
| } | |
| } | |
| } | |

The ACID field indicates which broadcast management message the data of a burst designated by the MAP_IE corresponds to. The AI_SN field indicates whether a currently transmitted burst is the first transmission of a burst or a retransmitted burst. The AI_SN field may have a toggle value of 1 bit or a value of 2 bits or more so that 2 or more change records can be traced. The management message type may be identical to that used in the IEEE 802.16 system, or may be defined depending on the types of broadcast management messages being implemented.

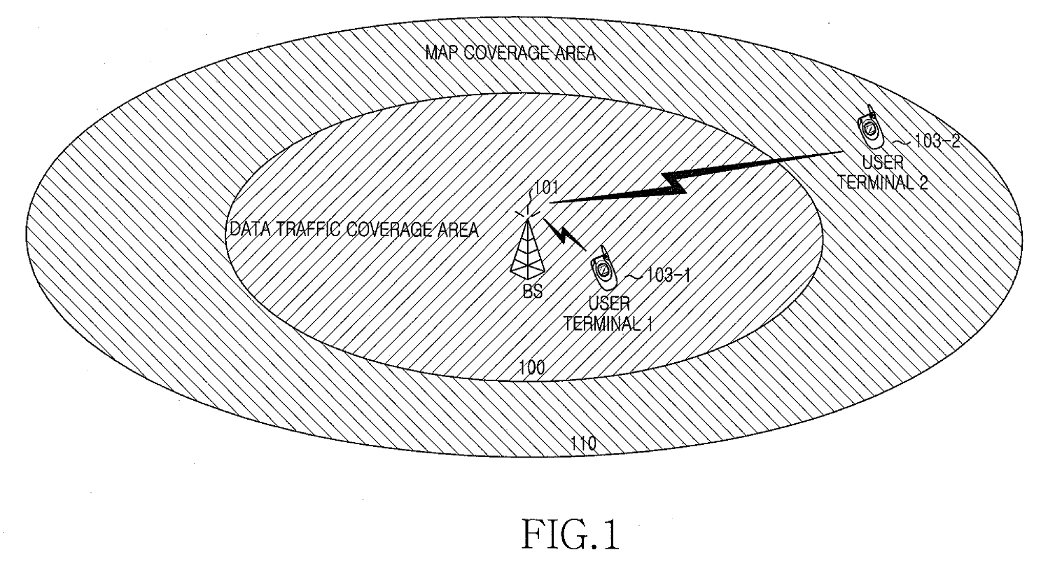

FIG. 1 is a diagram illustrating the service coverage area of a MAP message using a general data burst and a coverage area increasing scheme in a user terminal of a wireless communication system according to an exemplary embodiment of the present invention.

Referring to FIG. 1, a first user terminal 103-1 is located at the position where it can receive all data bursts transmitted from a base station 101, i.e., in a coverage area 100 for data traffic of the base station 101. On the other hand, a second user terminal 103-2 is located at the position where it can receive only a MAP message using a coverage area increasing scheme, i.e., in a MAP coverage area 110. Because the first user terminal 103-1 has good channel conditions and can successfully receive all data transmitted from the base station 101, it may operate in the conventional scheme. On the other hand, the second user terminal 103-2 receives a MAP message to detect whether there are bursts that are allocated and transmitted to itself in the current frame. If there is a burst with a broadcast CID among the above bursts, the second user terminal 103-2 determines which MAC management message type the burst is and whether the burst is retransmitted data or data being transmitted for the first time. It is assumed that the second user terminal 103-2 receives a MAC management message, fails to decode the received data, and stores the received data in a buffer. In this case, the second user terminal 103-2 determines whether data that has been received in a current frame can be combined with data stored in the buffer. That is, if an ACID value of data received in a previous frame that failed to be decoded is identical to an ACID value of data received in the current frame and if an AT_SN filed is not toggled, that is, if the currently transmitted burst is a retransmitted burst, the second user terminal 103-2 determines that the data received in the current frame and the data stored in the buffer data includes the same information. The second user terminal 103-2 then uses HARQ recombination. By using HARQ recombination, the reception success rate of the corresponding MAC management message is increased.

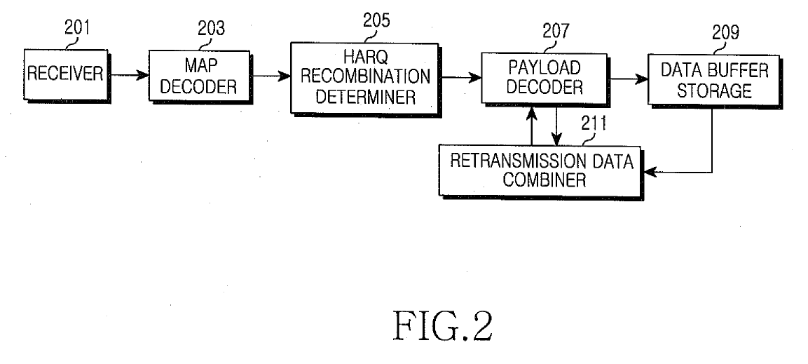

FIG. 2 is a block diagram of an apparatus for applying an HARQ scheme to a long management message in a user terminal of a wireless communication system according to an exemplary embodiment of the present invention.

Referring to FIG. 2, the apparatus includes a receiver 201, a MAP decoder 203, an HARQ recombination determiner 205, a payload decoder 207, a data buffer storage 209, and a retransmission data combiner 211.

The receiver 201 receives MAP information and a MAC management message for a burst designated by the MAP information from a base station.

The MAP decoder 203 decodes the received MAP message to detect information about a burst allocated to itself through a DL-MAP_IE included in the MAP message and information about a broadcast burst transmitted commonly to all the user terminals.

Based on the detection results, the HARQ recombination determiner 205 determines whether there is an HARQ-possible MAC management message among the downlink data bursts, whether the corresponding data corresponds to one of the MAC management messages, and whether the corresponding burst is the first occurrence of the transmitted burst or a retransmitted burst corresponding to the previously received data. Thereafter, the HARQ recombination determiner 205 performs the HARQ recombination depending on whether the newly received data in the current frame is identical to the data stored in the data buffer storage 209 due to a reception error. Moreover, the HARQ recombination determiner 205 may perform HARQ recombination if the newly received data in the current frame is substantially identical to the data stored in the data buffer storage 209.

The payload decoder 207 decodes a payload of the received MAC management message. Also, when the HARQ recombination of the corresponding MAC management message is performed by the HARQ recombination determiner 205, the payload decoder 207 outputs a payload of the received MAC management message to the retransmission data combiner 211 and decodes a payload of the MAC management message that is HARQ-recombined by the retransmission data combiner 211. If the decoding has failed, the payload decoder 207 stores a payload of the corresponding MAC management message in the data buffer storage 209.

The data buffer storage 209 stores a payload of the MAC management message that failed to be decoded in the previous frame.

The retransmission data combiner 211 receives a payload of a MAC management message that was newly received in the current frame from the payload decoder 207. Also, the retransmission data combiner 211 reads the stored MAC management message payload that was received in the previous frame. The retransmission data combiner 211 then performs HARQ recombination and outputs a payload of the HARQ-recombined MAC management message to the payload decoder

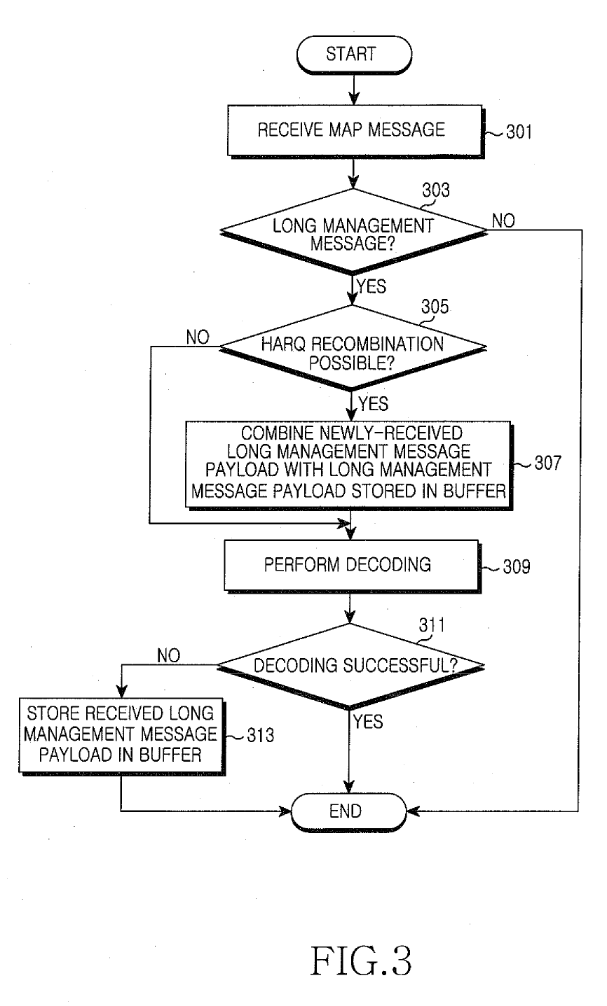

FIG. 3 is a flowchart illustrating a method for applying an HARQ scheme to a long management message in a user terminal of a wireless communication system according to an exemplary embodiment of the present invention.

The user terminal receives a broadcast MAC management message in the following three cases. The first case is where the user terminal has good channel conditions and thus can receive all data bursts without HARQ recombination. The second case is where the user terminal has poor channel conditions but can receive MAP information. The third case is where the user terminal has poor channel conditions and cannot receive the MAP information. In the third case, the user terminal cannot communicate with a base station until its channel conditions are improved. However, in the second case, a user terminal capable of receiving the MAP information can receive a MAC management message broadcast in the scheme proposed by the exemplary embodiments of the present invention.

When a broadcast MAC management message is to be transmitted in the current frame in the broadcast scheme, the base station constructs a MAP message by adding an ACID field and an AI_SN field for a broadcast CID as shown in Table 5.

Referring to FIG. 3, the user terminal receives a MAP message from the base station in step S301. In step S303, the user terminal decodes the received MAP message to check whether there is a long management message among downlink data bursts and whether there is a data burst that has a broadcast CID or a fragmentable broadcast CID. If there is no data burst that has a broadcast CID or a fragmentable broadcast CID (in step S303), the user terminal ends the method.

On the other hand, if there is a data burst that has a broadcast CID or a fragmentable broadcast CID (in step S303), the method proceeds to step S305. In step S305, based on an ACID field and an AI_SN field of the MAP message, the user terminal checks whether the corresponding data corresponds to one of the MAC management messages and whether the corresponding burst is a burst that has been transmitted for the first time or if it is a retransmitted burst corresponding to the previously received data. The user terminal then determines whether the MAC management message is identical to the data that has been stored in the data buffer storage 209 due to a reception error, thereby determining whether the corresponding MAC management message is a message capable of HARQ recombination. In this way, the user terminal checks the CID type included in the MAP_IE of the MAP message, thereby detecting which MAC management message the corresponding data corresponds to, without opening the MAC header of the corresponding burst.

If the HARQ recombination is possible, that is, if the MAC management message is identical to the data that has been stored in the data buffer storage 209 due to a reception error (in step S305), the method proceeds to step S307. In step S307, the user terminal reads the corresponding long management message payload from the data buffer storage 209, and combines the read payload with the payload of the newly received long management message. In step S309, the user terminal attempts to decode the resulting data. On the other hand, if the HARQ recombination is impossible, that is, if the MAC management message is different from data stored in the data buffer storage 209 due to a reception error (in step S305), the method proceeds directly to step S309.

In step S311, the user terminal checks whether the decoding has succeeded. If the decoding has succeeded (in step S309), the method is ended. On the other hand, if the decoding has failed (in step S309), the method proceeds to step S313. In step S313, the user terminal stores the received long management message payload in the data buffer storage 209. Thereafter, the method is ended.

According to the exemplary embodiments of the present invention described above, when a long management message, which includes a large amount of data and is infrequently changed, is transmitted in the wireless communication system, a base station transmits the MAP message. The MAP message includes information about the type of the long management message transmitted in the current frame and information about retransmission of the long management message for HARQ recombination. The MAP message is transmitted to a user terminal and the user terminal performs HARQ recombination for the long management message received from the base station. Thus, even a user terminal, which is located in a cell boundary region or has poor channel conditions, can receive the corresponding data. Therefore, it is possible to increase the service coverage area of the corresponding broadcast channel.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method for increasing the service coverage area of a broadcast channel in a wireless communication system, the method comprising:
receiving a MAP message comprising information about a type of a Media Access Control (MAC) management message transmitted in a current frame and information about retransmission of the MAC management message; and
upon receipt of the MAC management message, based on the received information, combining the received MAC management message with a MAC management message that is stored in a buffer, wherein the MAC management message that is stored in the buffer was stored due to a reception error.

2. The method of claim 1, further comprising:
decoding the combined MAC management message.

3. The method of claim 2, further comprising:
storing the received MAC management message in the buffer if the decoding has failed.

4. The method of claim 1, further comprising:
decoding the received MAC management message if the received MAC management message is a first transmission of the message or is different from a MAC management message that is stored in the buffer.

5. The method of claim 4, further comprising:
storing the received MAC management message in the buffer if the decoding has failed.

6. The method of claim 1, wherein the MAP message comprises at least one of a Channel ID (CID) field indicating a receiving point to receive the MAC management message, a field indicating the type of the MAC management message, and a field indicating information about retransmission of the MAC management message.

7. The method of claim 1, wherein the MAP message comprises a long management message.

8. An apparatus for increasing the service coverage area of a broadcast channel in a wireless communication system, the apparatus comprising:
a MAP decoder for decoding a received MAP message to extract information about a type of a Media Access Control (MAC) management message transmitted in the current frame and information about retransmission of the MAC management message; and
a Hybrid Automatic Repeat reQuest (HARQ) recombination determiner for determining, based on the extracted information, whether to combine the MAC management message transmitted in the current frame with the a MAC management message that is stored in a buffer, wherein the MAC management message that is stored in the buffer was stored due to a reception error.

9. The apparatus of claim 8, further comprising:
a retransmission data combiner for combining the MAC management message transmitted in the current frame with the MAC management message that is stored in the buffer; and
a payload decoder for decoding the combined MAC management message.

10. The apparatus of claim 9, wherein the payload decoder stores the received MAC management message in the buffer if the decoding has failed.

11. The apparatus of claim 8, wherein the HARQ recombination determiner determines that the received MAC management message is not combinable if the received MAC management message a first transmission of the message or is different from a MAC management message that is stored in the buffer due to a reception error, and the apparatus further comprises a payload decoder for decoding the MAC management message that is determined to not be combinable.

12. The apparatus of claim 11, wherein the payload decoder stores the received MAC management message in the buffer if the decoding has failed.

13. The apparatus of claim 8, wherein the MAP message comprises at least one of a Channel ID (CID) field indicating a receiving point to receive the MAC management message, a field indicating the type of the MAC management message, and a field indicating information about retransmission of the MAC management message.

14. The apparatus of claim 8, wherein the MAP message comprises a long management message.

15. A method for increasing the service coverage area of a broadcast channel in a wireless communication system, the method comprising:
receiving a message comprising information about a type of a management message transmitted and information about retransmission of the management message; and
upon receipt of the management message, based on the received information, combining the received management message with a management message that is stored in a buffer, wherein the management message that is stored in the buffer was stored due to a reception error.

16. The method of claim 15, further comprising:
decoding the combined management message.

17. The method of claim 16, further comprising:
storing the received management message in the buffer if the decoding has failed.

18. The method of claim 15, further comprising:
decoding the received management message if the received management message is a first transmission of the message or is different from the management message that is stored in the buffer.

19. The method of claim 18, further comprising:
storing the received management message in the buffer if the decoding has failed.

20. The method of claim 15, wherein the received message comprises at least one of a first field indicating a receiving point to receive the management message, a second field indicating the type of the management message, and a third field indicating information about retransmission of the management message.
